(19) United States
(12) Patent Application Publication
(10) Pub. No.: US 2011/0102449 A1
(43) Pub. Date: May 5, 2011

(54) Image Display Device, Image Display Method and Computer-Readable Information Recording Medium

(75) Inventor: Takahiro Toda, Tokyo (JP)

(73) Assignee: KONAMI DIGITAL ENTERTAINMENT CO., LTD., Tokyo (JP)

(21) Appl. No.: 12/610,867

(22) Filed: Nov. 2, 2009

(51) Int. Cl. G09G 5/02; G09G 5/00

(52) U.S. Cl. 345/589; 345/619

(57) ABSTRACT

An eye socket surface arranged in a virtual space cylindrically concaves from a face surface to the interior of a head, and a pupil surface is arranged back inside the eye socket surface. A memory unit stores contours, positions, directions, and textures of those surfaces, a position and direction of a projection point and a projection plane. An updating unit updates the position and direction of the projection point and the projection plane in accordance with an instruction input by a user. A generating unit projects individual surfaces on the projection plane based on the contour, position, and direction of the surfaces, positions and directions of the projection point and the projection plane, pastes a corresponding texture on each region in the projection plane, thereby generating an image of a character which looks like that a pupil is directed toward the projection point.

### BACKGROUND OF THE INVENTION

1. Field of the Invention

The present invention relates to an image display device and an image display method which are appropriate for displaying a three-dimensional character used in a computer game or the like in such a way that a pupil of the character is directed to a camera while suppressing consumption of memory capacities and computational resources, and a computer-readable information recording medium which records a program for realizing such a device and a method on a computer.

2. Description of the Related Art

Conventionally, in the field of three-dimensional computer graphics which generate an image used in a computer game, a contour of an individual object is defined (modeled) with a surface composed of combination of polygons or the like, and various textures are mapped on a surface of the polygon to express a texture of the model. For example, Japanese Patent No. 3737784 discloses a technique of storing an image of an vertically inverted background model arranged around a water surface model representing a water surface in a virtual three-dimensional space, changing a degree of transparency of the water surface model in a transparency changing area set based on a virtual camera viewpoint in the virtual three-dimensional space, pasting a texture (an image of vertically inverted background model) on the water surface model having the degree of transparency changed, and drawing by synthesizing the water surface model on which the texture is pasted and a background image.

Accordingly, when a pupil of a three-dimensional character is shown on the basis of the technique disclosed in Japanese Patent No. 3737784, it is necessary to prepare respective textures, such as a pupil directed to the front, a pupil directed to the right, and a pupil directed to the left, in accordance with directions of visual lines. If a direction of the pupil is changed directly, the pupil can be in a camera looking way (a visual line directed straight at a camera). However, in order to do so, a complicated programmatic control is required. For a game machine or the like which is under environment having limited computational resources, such a technique cannot be used in some cases in order to suppress consumption of memory capacities and computational resources. Accordingly, there is a demand for a technique which is appropriate for setting a pupil of a three-dimensional character to be a camera looking way while suppressing consumption of memory capacities and computational resources.

The present invention has been made in order to overcome the foregoing problem, and it is an objective of the present invention to provide an image display device and an image display method which are appropriate for displaying a character displayed on a game terminal or the like in such a way that a pupil of the character is directed to a camera while suppressing consumption of memory capacities and computational resources, and a computer-readable information recording medium which records a program for realizing such a device and a method on a computer.

### SUMMARY OF THE INVENTION

To achieve the objective, an image display device according to a first aspect of the present invention has a memory unit storing a surface contour (hereinafter, “face surface contour”) of a face of a character in a virtual space, a surface contour (hereinafter, “eye socket surface contour”) extending from an outer circumference of a region (hereinafter, “eye exposing region”) where an eye of the character is arranged in the face of the character to an interior of the face of the character, a surface contour (hereinafter, “pupil surface contour”) arranged in a region of the face surface contour which is surrounded by the eye exposing region and the eye socket surface contour, texture information (hereinafter, “face texture information”) which is for the face surface contour and which is pasted on at least a region (hereinafter, “face skin region”) other than the eye exposing region, texture information (hereinafter, “eye socket texture information”) which is for the eye socket surface contour, texture information (hereinafter, “pupil texture information”) which is for the pupil surface contour, a position of a projection point arranged in the virtual space, a position of a projection plane, and a direction thereof.

The eye socket surface contour represents a white part of an eye, extends so as to bore the internal side of the face, and has the internal side forming the front face. The eye socket texture is pasted on the internal side which is the front face of the eye socket surface contour. Conversely, the pupil surface contour is in a spherical shape, and represents a black part of an eye. The pupil surface contour is arranged inside the eye socket surface contour behind the face surface contour. The pupil surface contour and the face surface contour have the external sides which are the front faces, and respective textures are pasted on the external side faces.

The eye exposing region is a part where an eye is exposed in the front face of the face of the character, and the face skin region is a part of the front face of the face of the character other than the eye exposing region.

The projection point is a position of a virtual camera viewing a three-dimensional virtual space, and the projection plane is a plane where an object in the virtual space is projected in order to draw the virtual space on a two-dimensional plane. A direction of the projection point is calculated by an updating unit to be discussed later based on a position, a direction, and a zoom ratio, or the like of the virtual camera, and is stored in the memory unit.

Initial values of each surface contour, texture information, and position, direction and zoom ratio of the virtual camera are, for example, stored in an external memory medium like a DVD-ROM loaded in a DVD-ROM drive. Information read out from the DVD-ROM is temporarily stored in a volatile memory, typically, a RAM, and is updated as needed in accordance with progress of a game.

The image display device has also the updating unit updating respectively the stored position of the projection point, position of the projection plane and direction thereof to calculated values based on an instruction input by a user or in accordance with elapsed time.

That is, as the user gives an instruction to change a parameter for specifying a position of the virtual camera (projection point), a direction of the virtual camera (visual line vector), a zoom ratio of the virtual camera, or the like using an input device like a controller, the updating unit calculates a position of the projection plane and a direction thereof based on the input instruction, and stores those in the memory unit. Namely, the updating unit updates the arranged position of the projection plane and the direction thereof. The projection plane is arranged in a direction perpendicular to the visual line vector, and the position of the projection plane is calculated based on a zoom ratio and the like.

The image display device further has a generating unit calculating regions where the eye socket surface contour, the pupil surface contour, and the face surface contour are projected on the projection plane based on the position of the projection point, the position of the projection plane, the direction thereof, the eye socket surface contour, the pupil surface contour, and the face surface contour, pasting the eye socket texture information on a region where the eye socket surface contour is projected, pasting the pupil texture information on a region where the pupil surface contour is projected, and pasting the face texture information on a region where the face skin region is projected in a region where the face surface contour is projected, thereby generating an image of the virtual space as viewed from the projection point.

That is, since the face surface contour is arranged outwardly of the eye socket surface contour and the pupil surface contour, if a transparency of the face texture pasted on the eye exposing region is set to be completely transparent, the face texture is not drawn at the eye exposing region, but the eye socket surface contour and the pupil surface contour arranged inwardly of the face surface contour are drawn. At this time, the pupil surface contour is arranged at the back (in the depth direction) of the eye exposing region in the eye socket surface contour, and is drawn at the back of the eye exposing region, so that it becomes possible to display the character that a visual line thereof is directed to a camera.

There is a technique that uses the face texture information as a nontransparent texture pasted on the face skin part other than the eye exposing region, and in this case, no face texture information is pasted on a part where the eye exposing region is projected.

Conversely, when the face texture is used as a texture pasted on the whole face, it is typical that the eye exposing region is set to be a completely transparent texture, and the face skin region is set to be a nontransparent texture. According to this setting, when the face texture is pasted on, the eye exposing region is pasted on with a complete transparency, and the face skin region is pasted on with a predetermined transparency (typically, completely nontransparent).

Still further, the image display device has a display unit displaying the generated image. The generating unit normally stores the drawn image data in a frame buffer or the like, and when a vertical blank interruption occurs, transfers the content of the frame buffer to the display unit. The display unit displays the image data generated by the generating unit.

According to the foregoing fashion, it becomes possible to display and draw a virtual character which looks like as if the visual line thereof is directed to a camera without actually moving the pupil surface or preparing plural textures for the eye exposing region.

The memory unit may further store a position of a light source lighting up the virtual space. In this case, the generating unit may paste the eye socket texture information with a predetermined brightness, paste the pupil texture information with a brightness defined based on the position of the light source and the pupil surface contour or a predetermined value, and paste the face texture information with a brightness defined based on the position of the light source and the face surface contour.

That is, in general, when a texture is pasted on a surface, a brightness of the texture is changed based on a position of the light source relative to the plane of the surface, but regardless of the position of the light source, the eye socket texture is pasted on with a predetermined brightness. This eliminates the solidity of the eye socket texture, and causes the eye socket texture to look like as if it is a white part of an eye. The same is true of the pupil texture, and when it is not desirable that a black part of an eye looks like having solidity, the texture information is pasted with a predetermined brightness. Conversely, when it is desirable that the black part of the eye looks like having solidity, the texture is pasted on while changing the brightness in accordance with the position of the light source.

According to the foregoing fashion, the white part of the eye does not have solidity but has a constant brightness, while the brightness of the pupil can be changed in accordance with cases, so that it becomes possible to draw the eye of the character more realistic.

The generating unit may change over a degree of transparency when the face texture information is pasted on the eye exposing region either completely transparent or nontransparent in accordance with elapsed time or an instruction given by the user. That is, when a degree of transparency of the face texture when pasted on the eye exposing region is set to be completely transparent, a visual line (camera looking way) looks like that the eye is directed to a camera can be obtained as explained above. Conversely, when the degree of transparency is set to be completely nontransparent, corresponding face texture information is drawn at the eye exposing region. Accordingly, when the degree of transparency when the texture information is pasted on the eye exposing region is changed over from completely transparent to completely nontransparent, it becomes possible to instantaneously draw an eye condition other than the camera looking way.

In this case, as explained above, the face texture information should comprise texture information pasted on the eye exposing region and texture information pasted on the face skin region.

According to the foregoing fashion, it becomes possible to easily change over the direction of the eye of the character.

The memory unit may further store plural pieces of information on polygons respectively comprising the eye socket surface contour, the pupil surface contour, and the face surface contour, and the generating unit may calculate regions where polygons respectively comprising the eye socket surface contour, the pupil surface contour, and the face surface contour are projected on the projection plane, and paste texture information associated with the region where the polygon is projected in the order of decreasing distance from the projection point.

That is, the generating unit can overwrite and draw in the order of the eye socket surface contour, the pupil surface contour, and the face surface contour, to perform a hidden-surface removal, but a polygon having a distance closest to the projection point may be drawn eventually by comparing positional relationships of all polygons from the projection point.

Through the foregoing fashion, a hidden-surface removal based on a Z-buffering or the like is carried out, and it becomes possible to perform drawing at a fast speed with a simple algorithm.

An image display method according to another aspect of the present invention comprises steps of controlling an image display device having a memory unit, an updating unit, a generating unit, and a display unit.

First, in a memory step, the memory unit stores a surface contour (hereinafter, “face surface contour”) of a face of a character in a virtual space, a surface contour (hereinafter, “eye socket surface contour”) extending from an outer circumference of a region (hereinafter, “eye exposing region”) where an eye of the character is arranged in the face of the character to an interior of the face of the character, a surface contour (hereinafter, “pupil surface contour”) arranged in a region of the face surface contour which is surrounded by the eye exposing region and the eye socket surface contour, texture information (hereinafter, “face texture information”) which is for the face surface contour and which is pasted on at least a region (hereinafter, “face skin region”) other than the eye exposing region, texture information (hereinafter, “eye socket texture information”) which is for the eye socket surface contour, texture information (hereinafter, “pupil texture information”) which is for the pupil surface contour, a position of a projection point arranged in the virtual space, a position of a projection plane, and a direction thereof.

In an updating step, the updating unit respectively updates the stored position of the projection point, position of the projection plane and direction thereof to predetermined values based on an instruction input by a user or in accordance with elapsed time.

In a generating step, the generating unit calculates regions where the eye socket surface contour, the pupil surface contour, and the face surface contour are projected on the projection plane based on the position of the projection point, the position of the projection plane, the direction thereof, the eye socket surface contour, the pupil surface contour, and the face surface contour, pastes the eye socket texture information on a region where the eye socket surface contour is projected, pastes the pupil texture information on a region where the pupil surface contour is projected, and pastes the face texture information on a region where the face skin region is projected in regions where the face surface contour is projected, thereby generating an image of the virtual space as viewed from the projection point.

In a display step, the display unit displays the generated image.

According to the foregoing method, it becomes possible to display and draw a virtual character which looks like as if the visual line thereof is directed to a camera without actually moving the pupil surface or preparing plural textures for the eye exposing region.

A program according to yet another aspect of the present invention allows a computer to function as the foregoing image display device. The program allows the computer to execute the foregoing image display method.

Moreover, the program of the present invention can be recorded in a computer-readable recording medium, such as a compact disk, a flexible disk, a hard disk, a magneto-optical disk, a digital video disk, a magnetic tape, and a semiconductor memory. The program can be independently distributed and sold over a computer network from a computer which executes the program. Also, the program can be distributed and sold independently from the computer.

According to the present invention, there are provided an image display device and an image display method which are suitable for displaying a character displayed on a game terminal or the like in such a way that a pupil of the character is directed to a camera while suppressing any consumption of memory capacities and computational resources, and a computer-readable information recording medium which records a program for realizing such a device and a method over a computer.

### BRIEF DESCRIPTION OF THE DRAWINGS

These objects and other objects and advantages of the present invention will become more apparent upon reading of the following detailed description and the accompanying drawings in which:

FIG. 1 is a pattern diagram showing a schematic configuration of a game device typical of realizing a game terminal or the like according to an embodiment of the present invention;

FIG. 2 is a diagram for explaining a schematic configuration of an image processing device according to the embodiment;

FIG. 3 is a diagram showing an example of a head object;

FIG. 4 is a flowchart showing flows of a process executed by the image processing device;

FIG. 5A is a diagram showing a positional relationship among objects;

FIG. 5B is a diagram showing an example of a head drawn using a technique of the present invention;

FIG. 6A is a diagram showing an example of a face texture;

FIG. 6B is a diagram showing an example of a transparent filter applied to the face texture;

FIG. 7A is a diagram showing an example of a head drawn by using the technique of the present invention and viewed from the front;

FIG. 7B is a diagram showing an example of a drawn face by using the face texture;

FIG. 8A is a diagram showing a face texture in the vicinity of an eye-exposing region with a technique of representing stars in a black eye;

FIG. 8B is a diagram showing an example of a transparent filter applied to a face texture with the technique of representing stars in a black eye;

FIG. 8C is a diagram showing examples of drawn eye socket and pupil with the technique of representing stars in a black eye;

FIG. 8D is a diagram showing an example case when the face texture shown in FIG. 8A to which the transparent filter of FIG. 8B is applied is drawn over FIG. 8C with the technique of representing stars in a black eye;

FIG. 9A is a diagram showing an example of a typical “cartoon eye”;

FIG. 9B is a diagram showing an example of a typical “cartoon eye”;

FIG. 9C is a diagram showing an example of a contour of a pupil object;

FIG. 9D is a diagram showing a contour of an eye-exposing region;

FIG. 9E is a diagram showing an example of a pupil drawn by using the contours of FIGS. 9C and 9D with the technique of the present invention;

FIG. 9F is a diagram showing an example of a pupil drawn by using the contours of FIGS. 9C and 9D with the technique of the present invention; and

FIG. 10 is a diagram showing an example of a disk-shaped pupil object.

### DETAILED DESCRIPTION OF THE PREFERRED EMBODIMENT

An embodiment of the present invention will be described below. For ease of understanding, the embodiments below of the present invention is described as an application to game devices. However, the present invention may be similarly applied to information processing devices, such as various computers, PDAs, and mobile phones. In other words, the embodiment described below is provided to give an explanation, not to limit the scope of the present invention. Therefore, those skilled in the art can adopt embodiments in which some or all of the elements herein have been replaced with respective equivalents, and such embodiments are also within the scope of the present invention.

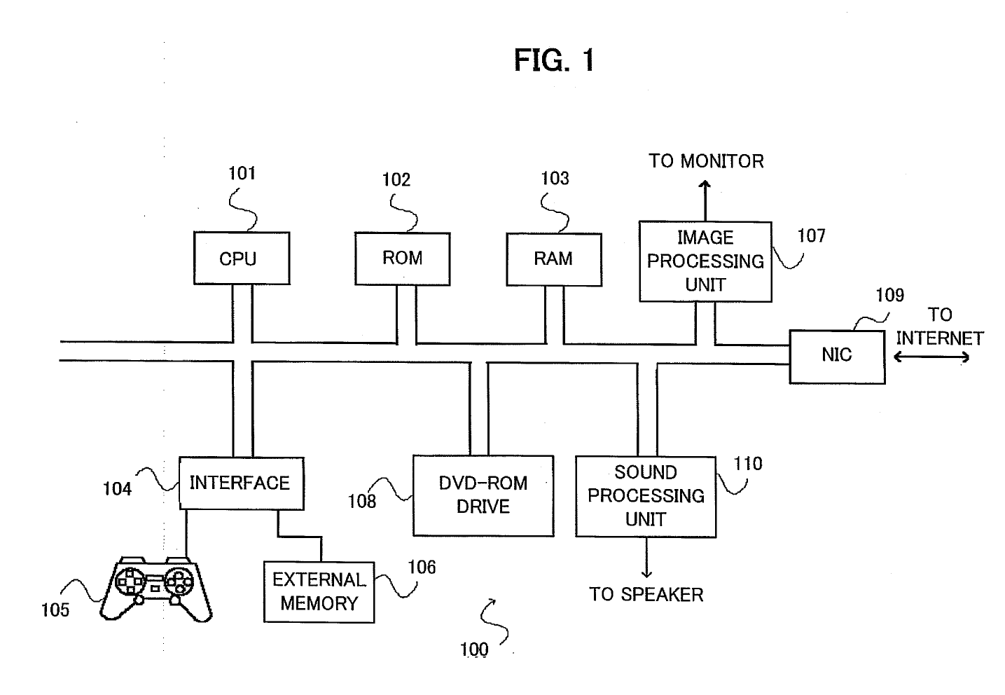

FIG. 1 is a pattern diagram showing a schematic configuration of a game device typical of realizing a game terminal according to an embodiment of the present invention. An explanation will be given with reference to this diagram.

A game device 100 includes a Central Processing Unit (CPU) 101, a Read Only Memory (ROM) 102, a Random Access Memory (RAM) 103, an interface 104, a controller 105, an external memory 106, an image processing unit 107, a Digital Versatile Disk (DVD)-ROM drive 108, a Network Interface Card (NIC) 109, and a sound processing unit 110.

When a DVD-ROM that stores a game program and data is loaded in the DVD-ROM drive 108 and the game device 100 is turned on, the program is executed and a terminal device of the embodiment is realized.

The CPU 101 controls the operation of the whole game device 100, and is connected to each component to exchange control signals and data with it.

An Initial Program Loader (IPL), which is executed immediately after the power is turned on, is stored in the ROM 102. Execution of IPL by CPU 101 makes a program stored on the DVD-ROM be read into the RAM 103 and begins operation of the program by the CPU 101.

Further, an operating system program and various data that are necessary for controlling the operation of the whole game device 100 are stored in the ROM 102.

The RAM 103 is a temporary memory for data and programs, and retains a program and data read out from the DVD-ROM and data necessary for game progressing and chat communications.

The controller 105 connected via the interface 104 receives an operation input given by a user for playing a game.

The external memory 106 detachably connected via the interface 104 stores log data on chat communications, etc using rewritable technology. As needed, a user can record such data into the external memory 106 by entering an instruction input via the controller unit 105. The external memory 106 may be an SD card or the like.

As described above, a DVD-ROM to be loaded in the DVD-ROM drive 108 stores a program for realizing a game and image data and sound data that accompany the game. Under the control of the CPU 101, the DVD-ROM drive 108 performs a reading process on the DVD-ROM loaded therein to read out a necessary program and data, which are to be temporarily stored in the RAM 103, etc.

The image processing unit 107 processes data read out from a DVD-ROM by means of the CPU 101 and an image calculation processor (not shown) possessed by the image processing unit 107, and records the processed data in a frame memory (not shown) possessed by the image processing unit 107. Image information recorded in the frame memory is converted to video signals at predetermined synchronization timings and output to a monitor (not shown) connected to the image processing unit 107. This enables various types of image display.

The image calculation processor can perform, at a high speed, overlay calculation of two-dimensional images, transparency calculation such as α blending, etc., and various saturation calculations.

The image calculation processor can also perform a high-speed calculation of rendering polygon information that is arranged in a virtual three-dimensional space and affixed with various pieces of texture information by Z buffering and obtain a rendered image of the polygon arranged in the virtual three-dimensional space as seen panoramically from a predetermined view position.

Furthermore, the CPU 101 and the image calculation processor can operate in cooperation to draw a string of letters as a two-dimensional image in the frame memory or on each polygon surface in accordance with font information that defines the shape of the letters. The font information is stored in the ROM 102, but dedicated font information stored in a DVD-ROM may be used.

The NIC 109 connects the game device 100 to a computer communication network (not shown) such as the Internet, etc. The NIC 109 is an interface (not shown) that intermediates the CPU 101 and a 10BASE-T/100BASE-T standard compliant product used for establishing a Local Area Network (LAN), an analog modem, an Integrated Services Digital Network (ISDN) modem, or an Asymmetric Digital Subscriber Line (ADSL) modem for establishing a connection to the Internet via a telephone line, a cable modem for establishing a connection to the Internet via a cable television line, or the like.

As the game device 100 is connected to an SNTP server over the Internet via the NIC 109 and information is acquired therefrom, the game device 100 can acquire current date information. Moreover, server devices of various network games may be so configured as to accomplish the same function as that of the SNTP server.

The sound processing unit 110 converts sound data read out from a DVD-ROM into analog sound signals and outputs such sound signals from a speaker (not shown) connected thereto. Under the control of the CPU 101, the sound processing unit 110 generates an effect sound or music data that shall be released in the progress of a game, and outputs a sound corresponding to such data from the speaker.

The game device 100 may use a large capacity external storage device such as a hard disk or the like and configure it to serve the same function as the ROM 102, the RAM 103, the external memory 106, a DVD-ROM loaded in the DVD-ROM drive 108, or the like.

Note that an image processing device 200 according to the embodiment is realized by the game device 100, a portable game device, or the like, but can be realized by an ordinary computer. For example, such a ordinary computer includes, like the game device 100 described above, a CPU a RAM, a ROM, a DVD-ROM drive, an NIC, an image processing unit with a simpler function than that of the game device 100, and has a hard disk drive as its external storage device with compatibility with a flexible disk, a magneto-optical disk, a magnetic tape. Such a computer uses a keyboard, a mouse, etc. instead of a controller as its input device. When a game program is installed on the computer and executed, the computer functions as the image processing device.

In the following description, an explanation will be given about the image processing device 200 through the configuration of the game device 100 in FIG. 1. The image processing device 200 can be appropriately replaced with an element of an ordinary computer as needed, and such an embodiment is within the scope of the present invention.

[Schematic Configuration of Image Processing Device]

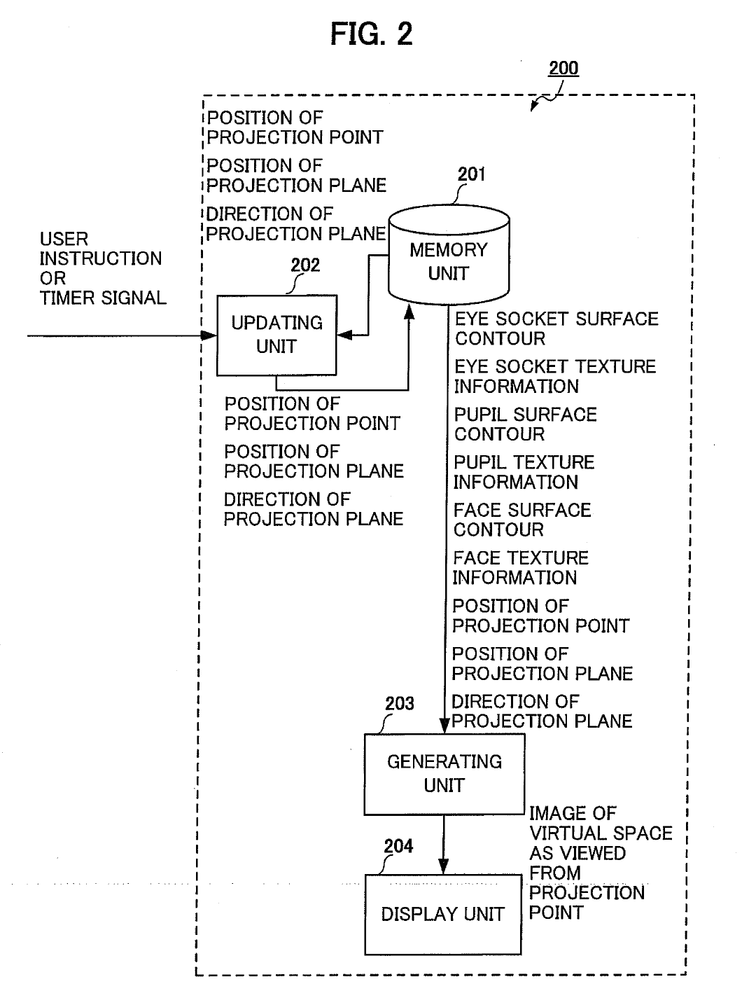

FIG. 2 is a pattern diagram showing a schematic configuration of the image processing device 200 according to the embodiment. An explanation will be given with reference to this figure.

The image processing device 200 controls a character in a three-dimensional virtual space in such a way that a pupil of the character is directed to a camera, and draws such a character in accordance with an instruction from a user or elapsed time. As shown in FIG. 2, the image processing device 200 has a memory unit 201, an updating unit 202, a generating unit 203, a display unit 204 and the like.

Individual units of the image processing device 200 will be explained below.

The memory unit 201 stores contour information of each element (called an object or a model) configuring a head object 300 of a character in the virtual space, information on a position where each element is arranged, and the like (note that plural objects may be grouped to define a larger object like the head object 300). Such pieces of information are stored in, for example, a DVD-ROM beforehand and the CPU 101 reads out such pieces of information from the DVD-ROM loaded in the DVD-ROM drive 108, and further stored temporarily in the RAM 103. Alternatively, such pieces of information may be stored in the external memory 106 beforehand, and the CPU 101 may read out such pieces of information and temporarily store those in the RAM 103. The CPU 101 can update temporarily-stored information as needed in accordance with, for example, the progress of a game. The CPU 101, the RAM 103, the DVD-ROM drive 108, and the like work together to function as the memory unit 201.

An explanation will be given about information on each element configuring the head object 300 stored in the memory unit 201.

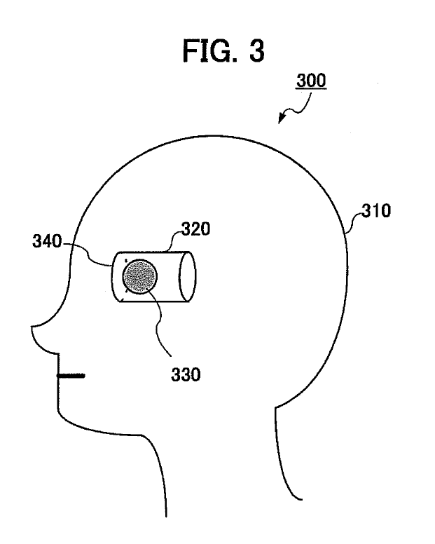

As shown in FIG. 3, the head object 300 comprises a face object 310, an eye socket object 320, a pupil object 330, and the like. The contour of each object is expressed as a surface defined by combination of tiny polygons (e.g., a triangle, a rectangle).

The memory unit 201 stores a “face surface contour” forming the face object 310, an “eye socket surface contour” forming the eye socket object 320 extending toward an interior of a face of the character from an outer circumference of an region (hereinafter, an “eye exposing region 340”) where a white part of an eye or a pupil is arranged, and a “pupil surface contour” forming the pupil object 330 arranged in a region surrounded by the eye exposing region 340 and the eye socket surface contour.

Note that the eye socket object 320 is for representing a white part of an eye, and the pupil object 330 is for representing a black part of an eye.

A surface contour is defined on the basis of a local coordinate system (a body coordinate system) prepared for each object. Typically, a gravity center of an object becomes an origin of the local coordinate system. Regarding the eye socket surface contour, a surface facing the internal side, i.e., a side where a pupil is arranged is defined as a front face, and eye socket texture information is pasted on such a front face which is the internal side. In contrast, regarding the face surface contour and the pupil surface contour, the external side is a front face, and face texture information and pupil texture information are pasted at the respective external sides.

The memory unit 201 also stores positional information of each object configuring the head object 300 in the virtual space and a direction thereof. For example, the memory unit 201 stores a global coordinate system (a world coordinate system) representing the whole virtual space and a local coordinate system fixed to each object. Typically, a representative point (a gravity center) of an object is an origin of the local coordinate system, and the local coordinate system can be defined by an amount of parallel displacement from the global coordinate system and a rotation amount therefrom. Accordingly, a position of an object and a direction thereof can be set through the local coordinate system.

Note that the positional information may be defined using a Cartesian coordinate system or a polar coordinate system (r, θ, and φ) with one moving radius and two deflection angles.

The contour of the eye socket object 320 is cylindrical in FIG. 3, but if the eye socket object 320 has one end opened at the eye exposing region 340 and has another end closed, the contour of such eye socket object 320 may be conical or spherical.

Moreover, if the pupil object 330 is arranged at a position located back from a position where the eye socket surface contour intersects the face surface contour (i.e., an edge of the eye exposing region 340), the pupil object 330 may have a larger diameter than that of the eye socket region 340, and may be in a shape like a cube having a rounded corners, instead of a spherical shape. The eye exposing region 340 may be formed in a perfect circular shape, an ellipsoidal shape, a rectangular shape having rounded corners, and the like as needed.

The memory unit 201 further stores image data called a texture pasted on a front face of an object. As the texture is pasted on, it becomes possible to express a texture of an object. The memory unit 201 stores face texture information, eye socket texture information, and pupil texture information for the face surface contour, the eye socket surface contour, and the pupil surface contour, respectively.

The memory unit 201 further stores a position of a projection point, a position of a projection plane and a direction thereof. A projection point is a view point of a virtual camera viewing an object in the virtual space. A projection plane is a two-dimensional plane where an appearance of the three-dimensional virtual space viewed from the projection point is projected. Yet further, the memory unit 201 stores a position of a light source lighting up the virtual space.

The updating unit 202 updates a position of a projection point, a position of a projection plane and a direction thereof based on an input instructed by a user through a manipulation of an input device connected via the interface 104 or a content of input instructed by the user through a program. The CPU 101 and the RAM 103 work together to function as the updating unit 202.

The generating unit 203 generates image data, in which an object is projected on the projection plane from the projection point in the three-dimensional virtual space based on each surface contour stored in the memory unit 201, a corresponding texture, a position of the projection point, the position of the projection plane and the direction thereof that are updated by the updating unit 202, and which is displayed on a monitor. The CPU 101, the RAM 103, and the image processing unit 107 work together to function as the generating unit 203. How the generating unit 203 projects an object will be explained in detail along with an explanation for an operational process of the generating unit 203.

The display unit 204 is a monitor (not shown) which displays image data generated by the generating unit 203.

[Operation of Image Processing Device]

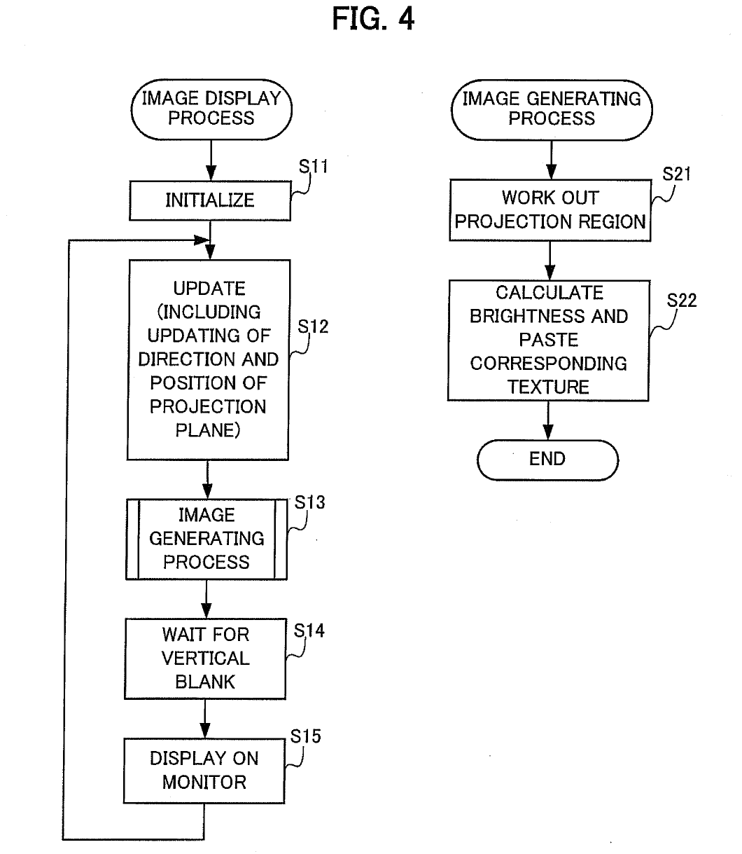

An explanation with reference to FIG. 4 will be given about an operation of the image processing device 200 which has the foregoing configuration and which draws and displays a face of a character arranged in the three-dimensional virtual space.

As the image processing device 200 is powered on and a process is initiated, necessary information (e.g., a position of a virtual camera, a direction thereof, a contour of an object, a position, and a direction thereof) are read in the RAM 103, and the memory unit 201 is initialized (step S11).

The user can give an instruction of changing parameters for setting a position of a virtual camera (projection point), a direction of the virtual camera (a direction of a visual line), a shooting magnification (a zoom ratio), and the like using the controller 105. When the user inputs such an instruction, the updating unit 202 updates the position of the virtual camera, the direction and the zoom ratio stored in the memory unit 201 in accordance with the input instruction (step S12). A position where a projection plane is arranged in the virtual space and a direction thereof are calculated in accordance with the position of the virtual camera, the direction and the zoom ratio.

That is, the updating unit 202 calculates a direction orthogonal to a visual line vector with a projection point being a source, and sets this calculated direction as the direction of the projection plane. In the case of zoom-in, the projection plane is shifted in parallel so as to come close to a shooting target (so as to be apart from the projection point) in the three-dimensional space, and in the case of zoom-out, the projection plane is moved in parallel so as to be apart from the shooting target (so as to come close to the projection point). When a direction of the visual line vector is changed (i.e., when the virtual camera is panned), a direction of the projection plane is changed in accordance with the direction of the visual line vector. In this fashion, the updating unit 202 sets a position of the projection plane and a direction thereof based on a position of the projection point, a viewing direction from the projection point (a direction of the visual line vector), and the zoom ratio, and stores (updates) the set information in the memory unit 201.

Note that the parameters for a position of the virtual camera, a direction thereof, and a shooting magnification may be given from a control program or the like, may be updated to predetermined values in association with an elapsed time, or may be changed at random.

Next, the generating unit 203 progresses the process to an image generating process (step S13), and draws a two-dimensional image of each object in the three-dimensional virtual space.

Typically, in order to execute a hidden-surface removal while suppressing calculation amount and consumption of the memories, for example, a method of acquiring a distance between a representative point (e.g., a gravitational point) of an object and the projection point, and of drawing objects in the order of decreasing distance is used. According to the embodiment, however, when drawing the head object 300, the generating unit 203 respectively executes the steps S21 to S22 in the order of the eye socket object 320, the pupil object 330, and the face object 310 to draw the head object 300 without calculating a distance between a representative point and the projection point. Since the face object 310 locates at the most external side, if drawing is carried out in the foregoing order, a pupil and an eye socket located inside the face object 310 are drawn first, and the face surface contour other than the eye exposing region 340 is drawn.

First, in the step S21, for each polygon defining a surface contour of an object currently in process, a projection destination (a part where each object is projected) in the projection plane when the projection plane is arranged in a position and a direction set in the step S12 is calculated. For example, the generating unit 203 projects each object on the projection plane as perspective. Accordingly, each object arranged in the three-dimensional virtual space is projected on a two-dimensional virtual screen. In the embodiment, a one-point perspective projection is used as a projection technique, so that an object apart from the projection point is projected as a smaller object, and an object in the vicinity of the projection point is projected as a larger object. However, a parallel projection may be used instead of the one-point perspective projection.

When the projection destination is calculated, a corresponding region of a corresponding texture (e.g., the eye socket texture for the eye socket surface contour) is pasted (mapped) on each region of the projection destination to draw an object (step S22). However, the generating unit 203 executes a hidden-surface removal for each object using a technique, for example, a Z-buffering, and draws the object. The Z-buffering is a technique of paining a pixel configuring image data to be drawn with a color of texture information corresponding to a closest polygon to the projection plane. When a direction of the visual line vector and a normal line vector of the surface contour of a polygon are same, it means that the surface is directed opposite to the visual line vector, so that the generating unit 203 may not draw such a surface.

When a texture is pasted, a direction of a polygon forming each object relative to a light source is considered. That is, the smaller an angle between a normal line from the rear of each polygon to the front thereof of a surface contour configuring an object and a directional vector from a position of the polygon toward the light source is, the higher the brightness of a texture is increased. In contrast, if such an angle becomes closer and closer to a right angle, the brightness is set lower and lower. When a texture is changed by multiplying the brightness by a reflectance, even if an angle between the normal line of a polygon and the directional vector is a right angle, the brightness is not completely set to 0. This enables expression of a texture (roughness, smoothness, and the like) at a dark part. Note that a cosine of the angle may be calculated by inner production of the vectors, and the brightness may be set higher and higher if the acquired cosine is closer and closer to 1. In order to make a difference of the brightness at a border of polygons unnoticeable, Gourand shading or Phong shading may be carried out.

However, when a texture is pasted on the eye socket object 320, the brightness is fixed to a predetermined value, and is not changed depending on an angle of the light source. As a result, a color of the eye socket becomes constant regardless of a direction of a polygon, and an unnatural solidity can be avoided.

Regarding the pupil object 330, if it is desirable that a black part of an eye should look like spherical, the brightness is set in consideration of a direction of the light source, and if it is not desirable, the brightness is set to a predetermined value. The reflectance may be set at random to make the black part of the eye not look like spherical.

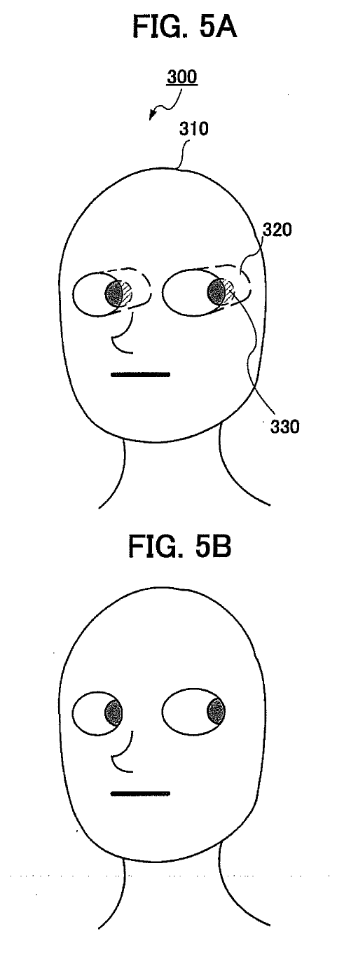

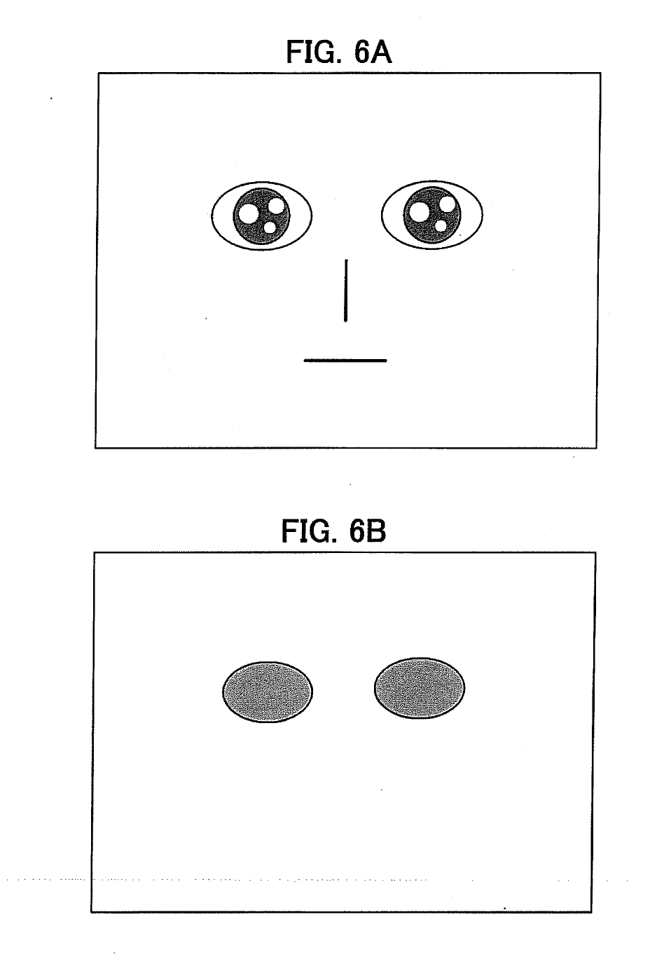

FIG. 5B shows an example in which the generating unit 203 draws the head object 300 in the order of the eye socket object 320, the pupil object 330, and the face object 310 when a virtual camera (a projection point) is arranged at the left as viewed from the head object 300. However, a transparent filter shown in FIG. 6B (meshed parts are completely transparent) is applied to a face texture shown in FIG. 6A to create FIG. 5B. Note that eye parts in FIG. 6A and meshed parts in FIG. 6B correspond to the eye exposing region 340.

Positional relationships among individual objects in the three-dimensional virtual space when FIG. 5B is drawn are shown in FIG. 5A, and the pupil object 330 is arranged back (in a depth direction) inside the eye socket object 320 as explained above. When the transparent filter shown in FIG. 6B is applied to the face texture, a region of the face texture corresponding to the eye exposing region 340 becomes completely transparent. Accordingly, even if the eye socket object 320, the pupil object 330, and the face object 310 are drawn in this order, the face texture is not overwritten on the eye socket and the pupil drawn in first at the eye exposing region 340. As a result, when the virtual camera is arranged in the oblique direction, as shown in FIG. 5B, the pupil is drawn back in the depth direction, and a visual line which looks like that the eye is in a camera looking way, i.e., is directed straight at the camera can be obtained.

Conversely, when the transparent filter is set to be completely nontransparent, a region of a face texture corresponding to the eye exposing region 340 is drawn. Accordingly, if a face texture containing an image of a pupil directed to the front as shown in FIG. 6A is prepared, a pupil directed to the front is pasted on the eye exposing region 340, and it becomes possible to draw a pupil looking the front, not in the camera looking way.

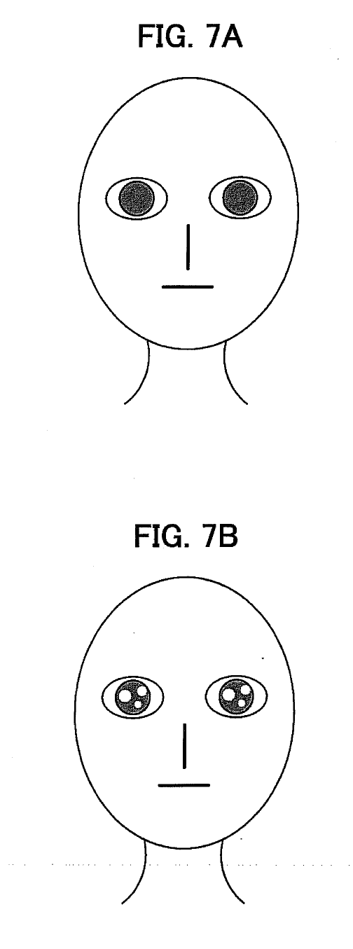

If the size of a pupil (a black part of an eye) and the position thereof differ between cases where a texture is pasted and drawn and a case where the pupil object 330 is projected and drawn, unnaturalness is caused when the transparent degree is changed. Accordingly, in the case that the head object 300 shown in FIG. 7A is drawn applying the completely transparent to the eye exposing region 340 of the face texture, the face texture (FIG. 6A) which makes the head object 300 drawn as shown in FIG. 7B is prepared when the filter is completely nontransparent. Note that it is supposed that the virtual camera is arranged at the front of the face when the face shown in FIG. 7A is drawn.

If an image of an eyelid is prepared for the face texture region corresponding to the eye exposing region 340 and the eye exposing region 340 is set to be nontransparent, it is possible to draw a condition that the eyelid is closed.

The degree of transparency of the transparent filter applied to the eye exposing region 340 can be changed in accordance with an input instructed by the user through manipulation of the input device connected via the interface 104, for example, in the case where the position of the virtual camera and the direction thereof are changed. Alternatively, a change instruction may be given from a control program or the like. The degree of transparency may be changed to a predetermined value in accordance with elapsed time, or may be changed at random.

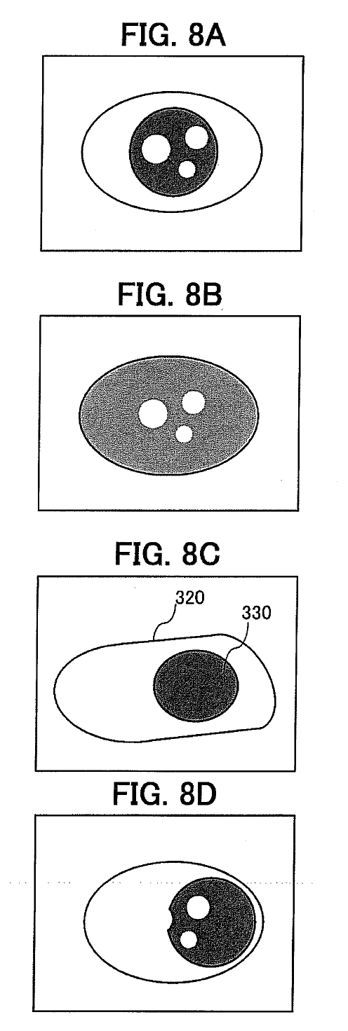

In accordance with the similar technique to the foregoing one, it is possible to express a “star” in an eye often seen in Japanese cartoons and animations. A “star” is an expression technique of exaggerating the twinkle in an eye, and is a drawing technique which draws a white maculation or a star-like tiny graphic in an eye. For example, a face texture having an image of a pupil containing stars as shown in FIG. 8A is prepared. A transparent filter shown in FIG. 8B is prepared for such a face texture. The transparent filter shown in FIG. 8B is similar to that of FIG. 6B, but portions corresponding to stars in a pupil of the face texture are set to be nontransparent, and the eye exposing region 340 other than the stars is set to be transparent (in the figure, a transparent part is indicated by meshing). FIG. 8C is an example representing a result when drawing is carried out by executing the steps S11 to S15, S21 and S22 with the virtual camera being arranged at the left as viewed from the face object 310 (a polygon of an eye socket surface which is not directed to the virtual camera is not drawn).

Next, when the face texture which is shown in FIG. 8A and to which the transparent filter shown in FIG. 8B has been applied is pasted on FIG. 8C to draw the face object 310, an eye image shown in FIG. 8D can be obtained. That is, an external side of the eye exposing region 340 and the star portions among the face texture are overwritten on FIG. 8C and drawn.

If a color of the star in the pupil in the face texture is set to be the same color as that of the eye socket texture, even if a star is partially chipped as shown in FIG. 8D, it looks like as if the star is fit in a white part of the eye, so that unnaturalness can be eliminated.

A star present in the pupil can be prepared as pupil texture information and mapped on the pupil surface. However, when it is desirable that the pupil should look like three-dimensional and spherical, a star drawn in the pupil texture unavoidably has solidity. In order to overcome this problem, the foregoing method of applying the transparent filter to the eye exposing region 340 to draw a star in the pupil is effective.

As the foregoing image generating process is completed, the generating unit 203 stands by until there is a vertical blank interruption (step S14). During the stand-by, another process (e.g., a process of updating a position of each object stored in the RAM 103 or the direction thereof based on elapsed time or an instruction from the user) may be executed as a call routine.

When a vertical blank interruption occurs, the generating unit 203 transfers the content of a drawn image data (generally stored in a frame buffer) in the display unit 204. The display unit 204 displays the transferred image (step S15), and the process returns to the step S12.

The embodiment of the present invention has been explained above, but the present invention is not limited to the foregoing embodiment, and can be changed and modified in various forms. Moreover, elements of the foregoing embodiment can be freely combined together.

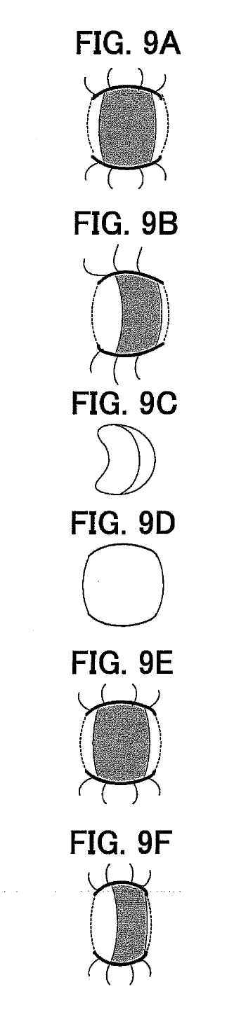

For example, FIGS. 9A and 9B show a typical Japanese “cartoon eye”. The “cartoon eye” shown in FIGS. 9A and 9B has right and left edges of a black part of the eye curved convexly and outwardly as viewed from the front as shown in FIG. 9A, and when it is viewed from the left of a head (on the observer's right) as shown in FIG. 9B, only left edge of the black part of the eye is curved and concaved inwardly. In order to realize such an eye, the contour of the pupil object 330 may be set to be in a concaved contour as shown in FIG. 9C, and the eye exposing region 340 may be set to be in a circular shape nearly a rectangle as shown in FIG. 9D. According to this setting, when a projection is carried out to a two-dimensional plane from the three-dimensional virtual space, as viewed from the front, an eye shown in FIG. 9E can be drawn, and as viewed from the left, an eye shown in FIG. 9F can be drawn. However, as is clear from FIG. 9F, when a camera is arranged in the oblique direction relative to a head to project a character on the two-dimensional plane, the eye of the character is drawn in such a way that the width thereof is slightly narrower than that when viewed from the front.

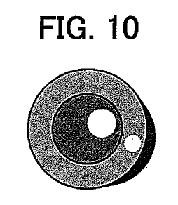

In addition to the pupil object 330 curved and concaved, a disk-shaped pupil object 330 may be prepared. With respect to the pupil object 330, black pupil texture for expressing a black part of an eye may be prepared. When a pupil used in typical Japanese animations and cartoons is drawn, pupil texture information may have a black part of an eye with two regions and may have a “star” representing the twinkle of the pupil in the black part of the eye. FIG. 10 shows an example of the disk-shaped pupil object 330 on which texture information is pasted.

When the pupil object 330 shown in FIG. 10 is drawn, a direction of the pupil object 330 may be controlled in such a way that a normal line vector of the pupil object 330 is directed to a projection point. This causes the pupil object 330 to be always directed to a camera even when a point of view is located in the oblique direction relative to the head object 300, so that the width of the pupil is not drawn narrowly, and it becomes possible to draw the pupil more effectively.

In the foregoing embodiment, a region corresponding to the eye exposing region 340 is contained in face texture information, and the control is carried out in such a manner as to determine whether a region corresponding to the eye exposing region 340 of the face texture information is drawn with the transparent filter. However, face texture information having regions other than the eye exposing region 340 (i.e., face skin region representing a skin of a face) may only be prepared, and eye socket texture information and pupil texture information may be pasted on the eye exposing region 340 so as to divide an eyelid in the vertical direction. This makes it possible to draw the eye socket object 320 and the pupil object 330 without the transparent filter.

Moreover, in the foregoing embodiment, when the generating unit 203 draws the head object 300, a projection region in the projection plane is calculated in the order of the eye socket object 320, the pupil object 330, and the face object 310, and corresponding texture information is pasted on. Since the face object 310 is located at the outermost side, a pupil and an eye socket located inside the face object 310 are drawn in first, and the face surface contour is drawn other than the eye exposing region 340 by drawing in accordance with the foregoing order. However, for example, the generating unit 203 may be operated in such a way that a Z-buffering is applied to all polygons configuring the surface contours of all objects and corresponding texture information associated with a region where the polygon is projected is pasted in the order of decreasing distances from the projection point to carry out drawing.

As explained above, according to the present invention, there are provided an image display device and an image display method which are suitable for displaying a character displayed on a game terminal or the like in such a way that a pupil of the character is directed to a camera while suppressing consumption of memory capacities and computational resources, and a computer-readable information recording medium which records a program for realizing such a device and a method on a computer.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2007-198488 filed on Jul. 31, 2008 and including specification, claims, drawings and summary. The disclosure of the above Japanese Patent Application is incorporated herein by reference in its entirety.

What is claimed is:

1. An image display device comprising:
a memory unit storing a surface contour (hereinafter, “face surface contour”) of a face of a character in a virtual space, a surface contour (hereinafter, “eye socket surface contour”) extending from an outer circumference of a region (hereinafter, “eye exposing region”) where an eye of the character is arranged in the face of the character to an interior of the face of the character, a surface contour (hereinafter, “pupil surface contour”) arranged in a region of the face surface contour which is surrounded by the eye exposing region and the eye socket surface contour, texture information (hereinafter, “face texture information”) which is for the face surface contour and which is pasted on at least a region (hereinafter, “face skin region”) other than the eye exposing region, texture information (hereinafter, “eye socket texture information”) which is for the eye socket surface contour, texture information (hereinafter, “pupil texture information”) which is for the pupil surface contour, a position of a projection point arranged in the virtual space, a position of a projection plane, and a direction thereof;
an updating unit respectively updating the stored position of the projection point, position of the projection plane and direction thereof to calculated values based on an instruction input by a user or in accordance with elapsed time;
a generating unit calculating regions where the eye socket surface contour, the pupil surface contour, and the face surface contour are projected on the projection plane based on the position of the projection point, the position of the projection plane, the direction thereof, the eye socket surface contour, the pupil surface contour, and the face surface contour, pasting the eye socket texture information on a region where the eye socket surface contour is projected, pasting the pupil texture information on a region where the pupil surface contour is projected, and pasting the face texture information on a region where the face skin region is projected in a region where the face surface contour is projected, thereby generating an image of the virtual space as viewed from the projection point; and
a display unit displaying the generated image.

2. The image display device according to claim 1, wherein
the memory unit further stores a position of a light source lighting up the virtual space, and
the generating unit pastes the eye socket texture information with a predetermined brightness, pastes the pupil texture information with a brightness defined based on the position of the light source and the pupil surface contour or a predetermined brightness, and pastes the face texture information with a brightness defined based on the position of the light source and the face surface contour.

3. The image display device according to claim 1, wherein
the face texture information comprises texture information pasted on the eye exposing region and texture information pasted on the face skin region, and
the generating unit changes over a degree of transparency when the face texture information is pasted on the eye exposing region either completely transparent or nontransparent in accordance with elapsed time or an instruction given by the user.

4. The image display device according to claim 1, wherein
the memory unit further stores plural pieces of information on polygons respectively comprising the eye socket surface contour, the pupil surface contour, and the face surface contour, and
the generating unit calculates regions where polygons respectively comprising the eye socket surface contour, the pupil surface contour, and the face surface contour are projected on the projection plane, and pastes texture information associated with the region where the polygon is projected in the order of decreasing distances from the projection point.

5. An image display method for controlling an image display device having a memory unit, an updating unit, a generating unit, and a display unit, the method comprising:
a memory step in which the memory unit stores a surface contour (hereinafter, “face surface contour”) of a face of a character in a virtual space, a surface contour (hereinafter, “eye socket surface contour”) extending from an outer circumference of a region (hereinafter, “eye exposing region”) where an eye of the character is arranged in the face of the character to an interior of the face of the character, a surface contour (hereinafter, “pupil surface contour”) arranged in a region of the face surface contour which is surrounded by the eye exposing region and the eye socket surface contour, texture information (hereinafter, “face texture information”) which is for the face surface contour and which is pasted on at least a region (hereinafter, “face skin region”) other than the eye exposing region, texture information (hereinafter, “eye socket texture information”) which is for the eye socket surface contour, texture information (hereinafter, “pupil texture information”) which is for the pupil surface contour, a position of a projection point arranged in the virtual space, a position of a projection plane, and a direction thereof;
an updating step in which the updating unit respectively updates the stored position of the projection point, position of the projection plane and direction thereof to calculated values based on an instruction input by a user or in accordance with elapsed time;
a generating step in which the generating unit calculates regions where the eye socket surface contour, the pupil surface contour, and the face surface contour are projected on the projection plane based on the position of the projection point, the position of the projection plane, the direction thereof, the eye socket surface contour, the pupil surface contour, and the face surface contour, pastes the eye socket texture information on a region where the eye socket surface contour is projected, pastes the pupil texture information on a region where the pupil surface contour is projected, and pastes the face texture information on a region where the face skin region is projected in regions where the face surface contour is projected, thereby generating an image of the virtual space as viewed from the projection point; and
a display step in which the display unit displays the generated image.

6. A computer-readable information recording medium storing a program that allows a computer to function as:
a memory unit storing a surface contour (hereinafter, “face surface contour”) of a face of a character in a virtual space, a surface contour (hereinafter, “eye socket surface contour”) extending from an outer circumference of a region (hereinafter, “eye exposing region”) where an eye of the character is arranged in the face of the character to an interior of the face of the character, a surface contour (hereinafter, “pupil surface contour”) arranged in a region of the face surface contour which is surrounded by the eye exposing region and the eye socket surface contour, texture information (hereinafter, “face texture information”) which is for the face surface contour and which is pasted on at least a region (hereinafter, “face skin region”) other than the eye exposing region, texture information (hereinafter, “eye socket texture information”) which is for the eye socket surface contour, texture information (hereinafter, “pupil texture information”) which is for the pupil surface contour, a position of a projection point arranged in the virtual space, a position of a projection plane, and a direction thereof;
an updating unit respectively updating the stored position of the projection point, position of the projection plane and direction thereof to calculated values based on an instruction input by a user or in accordance with elapsed time;
a generating unit calculating regions where the eye socket surface contour, the pupil surface contour, and the face surface contour are projected on the projection plane based on the position of the projection point, the position of the projection plane, the direction thereof, the eye socket surface contour, the pupil surface contour, and the face surface contour, pasting the eye socket texture information on a region where the eye socket surface contour is projected, pasting the pupil texture information on a region where the pupil surface contour is projected, and pasting the face texture information on a region where the face skin region is projected in a region where the face surface contour is projected, thereby generating an image of the virtual space as viewed from the projection point; and
a display unit displaying the generated image.
